(19) United States
(12) Patent Application Publication
(10) Pub. No.: US 2023/0174791 A1
(43) Pub. Date: Jun. 8, 2023

(54) Composition for Matting and Reducing Anti-Fingerprint Effects of Surfaces on Carrier Materials

(71) Applicant: Flooring Technologies Ltd., Kalkara (MT)

(72) Inventors: Andreas Gier, Mandelbachtal (DE); Norbert Kalwa, Horn-Bad Meinberg (DE)

(21) Appl. No.: 17/922,297

(22) PCT Filed: Apr. 27, 2021
(86) PCT No.: PCT/EP2021/060988

§ 371 Date: Oct. 28, 2022

(30) Foreign Application Priority Data
Apr. 30, 2020 (EP) 20172323.6

(51) Int. Cl. C09D 5/00; C09D 7/42; C09D 7/62; C09D 7/65; C09D 161/28; D21H 21/16; D21H 19/62; D21H 19/40

(52) U.S. Cl. CPC C09D 5/00; C09D 7/42; C09D 7/62; C09D 7/65; C09D 161/28; D21H 21/16; D21H 19/62; D21H 19/40

(57) ABSTRACT

The present invention relates to a resin suspension based on a formaldehyde resin comprising a composition for matting and reducing anti-fingerprint effects of surfaces on carrier materials, in particular paper layers and wood-based panels, wherein the composition comprises silane compounds and at least one matting agent. The invention further relates to a process for the preparation thereof, the use of said composition, and support materials, such as paper layers or wood-based panels, with said composition.

### CROSS-REFERENCE TO RELATED APPLICATIONS

This application is the United States national phase of International Application No. PCT/EP2021/060988 filed Apr. 27, 2021, and claims priority to European Patent Application No. 20172323.6 filed Apr. 30, 2020, the disclosures of which are hereby incorporated by reference in their entireties.

### BACKGROUND OF THE INVENTION

### Field of the Invention

The disclosure relates to a composition for matting and reducing anti-fingerprint effects of surfaces on carrier materials, a method for the preparation thereof, the use of said composition and carrier materials, such as paper layers or wood-based panels, with said composition.

### Description of Related Art

For many products that are used in daily life as objects of daily use, etc., the surface design is an important aspect in addition to the colour design. Sometimes the two aspects complement each other, sometimes they are deliberately designed in opposition to each other.

Of course, in addition to the purely visual design, the question of what properties a surface provides for practical use also plays a role. This is particularly true for interior design objects such as furniture, whose surfaces are heavily stressed by being touched, cleaned, etc.

High-gloss fronts in kitchens are a very striking example of this. When these fronts are touched, fingerprints are often visible. This is especially true when melamine or lacquer surfaces are involved. These seem to be particularly predestined to show fingerprints after being touched. The marking of fingerprints means that the surfaces have to be cleaned frequently, which is by no means desirable.

However, it should be noted with regard to melamine surfaces that they have a very high mechanical and chemical resistance, which gives them clear advantages over thermoplastic films or lacquers. In addition, almost any surface finish can be produced by etching the press plates used in the manufacture of melamine resin-coated wood-based panels.

As already mentioned, the surface design is an important aspect of products. As with almost all products, this is subject to fashion trends. A few years ago, high-gloss surface finishes were very popular for many products, but now people are more interested in matt surfaces. With these surfaces, too, fingerprints are of course undesirable after touching or are considered a defect.

The resulting disadvantages are therefore of a visual nature combined with an increased cleaning effort.

### SUMMARY OF THE INVENTION

It is a technical object underlying the proposed solution to create a surface with a low gloss level and simultaneous anti-fingerprint properties. It should be possible to use the existing material systems. It should also be possible to use the existing equipment. The resulting products should have the same surface properties as standard melamine surfaces.

This object is solved by a method having features as described herein.

Accordingly, there is provided a resin suspension based on a formaldehyde resin comprising a composition for matting and reducing anti-fingerprint effects of surfaces on carrier materials, the composition being preparable from
at least one compound of the general formula (I)

SiX₄ (I),
where
   X is H, OH or a hydrolysable moiety selected from the group comprising halogen, alkoxy, carboxy, amino, monoalkylamino or dialkylamino, aryloxy, acyloxy, alkylcarbonyl;
at least one compound of the general formula (II)

R¹ₐ SiX₍₄₋ₐ₎ (II),
where
   X has the above meaning, and
   R¹ is an organic moiety selected from the group comprising alkyl, aryl, cycloalkyl, and
   wherein R¹ has at least one functional group Q₁ selected from a group containing a hydroxy, amino, monoalkylamino, carboxy, mercapto, alkoxy, aldehyde, acrylic, acryloxy, methacrylic, methacryloxy, cyano, isocyano and epoxy group, and
   a=1, 2, 3, in particular 1 or 2, and
at least one compound of the general formula (III)

R²_{b} SiX_{(4-b)} (III),
where
   X has the above meaning,
   R² is a non-hydrolysable organic moiety R² selected from the group comprising alkyl, aryl, alkenyl, alkynyl, cycloalkyl, cycloalkenyl or perfluorinated alkyl; and
   b=1, 2, 3, or 4, and
at least one matting agent comprising polymers and silica.

### DESCRIPTION OF THE INVENTION

The present composition comprises a cross-linking, hydrophilic component with the compounds of the general formula (I) and (II) and a hydrophobic component with the compound of the general formula (III). The silane compound of formula (I) serves to build up an SiO₂ network via condensation of the OH groups, bonding to melamine resin and matting agent. The silane compound of formula (II) binds to the melamine resin and matting agent via the functional groups. The silane compound of formula (III) enables the formation of a hydrophobic and oleophobic surface. In a polar medium, these functionalised silane will align to the air / layer interface and thus show an increased concentration at the surface.

The present composition may be added to coating or impregnating resins, such as melamine resins and/or urea resins. In the case of impregnating resins, the present composition may be applied to the upper surface of the core-impregnated paper layer (impregnate) after core impregnation of paper layers (decorative paper, overlay paper) with the commonly used impregnating resins and intermediate drying. However, the present composition can also be applied together or separately with a resin to a printed wood-based panel.

The use of the present composition offers various advantages. For example, a matt surface with gloss points of less than 10, preferably less than 8, more preferably less than 5, can be produced. The treated surface has anti-fingerprint properties and requires little cleaning effort compared to conventional surfaces.

The hydrolysable moiety X is advantageously selected from a group containing H, OH, fluorine, chlorine, bromine, iodine, C₁₋₆ -alkoxy, in particular methoxy, ethoxy, n-propoxy and butoxy, C₆₋₁₀-aryloxy, in particular phenoxy, C₂₋₇-acyloxy, in particular acetoxy or propionoxy, C₂₋₇-alkylcarbonyl, in particular acetyl, monoalkylamino or dialkylamino with C₁ to C₁₂, in particular C₁ to C₆. Particularly preferred is the moiety X H, OH or alkoxy, especially methoxy, ethoxy, n-propoxy or i-propoxy.

In a particularly preferred variant of the present composition, the compound of the general formula (I) corresponds to the formula Sikₕ where the moiety X is OH or alkoxy, in particular methoxy, ethoxy, n-propoxy or i-propoxy. The compounds tetramethoxysilane and tetraethoxysilane are particularly preferred.

The organic moiety R¹ of the compound of the general formula (II) is preferably selected from a group comprising C₁-C₃₀ -alkyl, in particular C₅-C₂₅-alkyl, C₂-C₆-alkenyl, C₃-C₈-cycloalkyl and C₃-C₈-cycloalkenyl. In one embodiment, the organic R¹ is selected from the group comprising methyl, ethyl, n-propyl, isopropyl, n-butyl, s-butyl, t-butyl, pentyl, hexyl, cyclohexyl, vinyl, 1-propenyl, 2-propenyl, butenyl, acetylenyl, propargyl, butadienyl or cyclohexadienyl, preferably methyl, ethyl, propyl or vinyl.

In one embodiment of the present composition, the at least one functional group Q¹ of the compound of the general formula (II) is selected from a group comprising epoxide, hydroxyl, ether, acryl, acryloxy, methacryl, methacryloxy, amino, alkoxy, cyano and/or isocyano group. Accordingly, the functional group 0¹ can advantageously have a residue with a double bond or an epoxide group, which can be activated and polymerised by means of UV radiation.

In a variant of the present composition, compounds of the general formula (II) according to R¹ₐ SiX₍₄₋ₐ₎, in particular R¹ SiX₃, with a functional group Q1 may be selected from methacryloxypropyltrimethoxysilane (MPTS), aminoethyl-aminopropyltrimethoxysilane, silanes with an epoxy functionalisation such as glycidyl-oxypropyltriethoxysilane, or silanes with a vinyl functionalisation such as vinyltrimethoxysilane.

As described, the moiety R¹ can have at least one functional group Q¹. In addition, the moiety R¹ can also be substituted with further moieties.

The term “substituted”, in use with “alkyl”, “alkenyl”, “aryl”, etc., denotes the substitution of one or more atoms, usually H atoms, by one or more of the following substituents, preferably by one or two of the following substituents: halogen, hydroxy, protected hydroxy, oxo, protected oxo, C₃-C₇-cycloalkyl, bicyclic alkyl, phenyl, naphthyl, amino, protected amino, monosubstituted amino, protected monosubstituted amino, disubstituted amino, guanidino, protected guanidino, a heterocyclic ring, a substituted heterocyclic ring, imidazolyl, indolyl, pyrrolidinyl, C₁-C₁₂-alkoxy, C₁-C₁₂-acyl, C₁-C₁₂-acyloxy, acryloyloxy, nitro, carboxy, protected carboxy, carbamoyl, cyano, methylsulfonylamino, thiol, C₁-C₁₀-alkylthio and C₁-C₁₀-alkylsulfonyl. The substituted alkyl groups, aryl groups, alkenyl groups, may be substituted once or several times and preferably 1 or 2 times, with the same or different substituents.

The term “alkynyl” as used herein means a moiety of the formula R—C≡C—, in particular a “C₂-C₆-alkynyl”. Examples of C₂-C₆-alkynyls include: ethynyl, propynyl, 2-butynyl, 2-pentinyl, 3-pentinyl, 2-hexynyl, 3-hexynyl, 4-hexynyl, vinyl, and di- and tri-ynyls of straight and branched alkyl chains.

The term “aryl” as used herein means aromatic hydrocarbons, for example, phenyl, benzyl, naphthyl, or anthryl. Substituted aryl groups are aryl groups substituted with one or more substituents as defined above.

The term “cycloalkyl” includes the groups cyclopropyl, cyclobutyl, cyclopentyl, cyclohexyl and cycloheptyl.

In a further embodiment of the present composition, the non-hydrolyzable organic moiety R² of the compound according to formula (III) is selected from a group comprising C₁-C₁₅-alkyl, in particular C₁-C₁₀-alkyl, C₂-C₆-alkenyl, C₂-C₆-alkynyl and C₆-C₁₀-aryl. These may be unsubstituted or substituted with another hydrophobic group.

It is preferred if the non-hydrolysable organic moiety R² of the compound of the general formula (III) is selected from the group comprising methyl, ethyl, n-propyl, isopropyl, n-butyl, s-butyl, t-butyl, pentyl, hexyl, heptyl, octyl, nonyl, cyclohexyl, vinyl, 1-propenyl, 2-propenyl, butenyl, acetylenyl, propargyl, phenyl and naphthyl. Particularly preferred are methyl, ethyl, propyl, pentyl, octyl, or phenyl moieties.

In the context of the proposed solution, the term “non-hydrolysable organic residue” means an organic residue which, in the presence of water, does not lead to the formation of an OH group or NH₂ group linked to the Si atom.

The compound of general formula (III) may in particular comprise one of the following formulae:
R² SiX₃ with R² as C1-C10 alkyl group, preferably methyl, ethyl, propyl, pentyl, hexyl, heptyl, octyl, or as C6-C10 aryl group, preferably phenyl and with X as alkoxy, in particular methoxy, ethoxy, n-propoxy or i-propoxy, such as e.g. octyltriethoxysilane, phenyltriethoxysilane,
R² SiX₃ with R² as perfluorinated C1-C10 alkyl group, preferably perfluorinated methyl, ethyl, propyl, pentyl, hexyl, heptyl, octyl, in particular tridecafluorooctyl, perfluorooctyl, perfluoropentyl, pefluorhexyl.

In one variant, the present composition will have at least one compound of the general formula (I), at least one compound of the general formula (II) and at least two compounds of the general formula (III). However, at least one compound of the general formula (I) and at least two, preferably at least three compounds of the general formula (II) and at least two, preferably at least three compounds of the general formula (III) may also be present. Any combination is conceivable here.

Thus, in one variant, the composition may comprise tetraethoxysilane as a compound of formula (I), glycidyloxypropyltriethoxysilane as a compound of formula (II), and octyltriethoxysilane and pentyltriethoxysilane as compounds of formula (III). In another variant, the composition may comprise tetraethoxysilane as a compound of formula (I), glycidyloxypropyltriethoxysilane as a compound of formula (II), and octyltriethoxysilane and tridecafluorooctyltriethoxysilane as compounds of formula (III).

In a further embodiment, the compound of the general formula (I) is present in the composition in a molar amount between 20 and 60, the compound of the general formula (II) is present in a molar amount between 20-60 and the compounds of the general formula (III) are present in a molar amount between 0.1-50.

The range of the molar amount indicated for the compound of the general compound (III) may refer to one compound or to the sum of two compounds or three compounds of the general formula (III).

The ratio of the silane compound of formula (I) to the silane compounds of formula (II) and (III) is preferably between 40/20/40.

In one embodiment of the present composition, the at least one matting agent comprises polymers and silica. One possible matting agent is known, for example, as Deuteron MM 659, which is a composite of polyurethane, e.g. polyurethane beads, and silica. It is important that the matting agent shows a suitable size in the particle distribution for the coating application. Other materials such as pure silica particles such as Syloid 244, a synthetic, amorphous silica, or Tospeals (monodisperse polysiloxane particles) are also possible. The matting agent should not increase the viscosity too much. All particles mentioned here show high light stability.

In a further embodiment, the present composition may contain inorganic particles, in particular SiO₂, Al₂ O₃, ZrO₂, TiO₂ particles. The particles preferably used in this case have a size between 2 and 400 nm, preferably between 2 and 100 nm, more preferably between 2 and 50 nm. The addition of the inorganic particles increases the solids content of the composition, which improves the application behaviour of the composition. Also, the addition of inorganic particles prevents shrinkage and cracking. The inorganic particles can be used in an amount range of 0.1 to 25 wt %, preferably 5 to 20 wt %, based on the solids content of the silane material (sol-gel material). A synthetic, amorphous SiO₂ is known, for example, under the trade name SYLOID 244.

The present composition is preferably used in aqueous form. However, it is also possible that the present composition contains only alcohol and little or no water, i.e. the silane compounds can be used in an alcoholic form.

The composition used herein can be prepared in a process comprising the following steps:
Providing an aqueous suspension containing at least one compound of the general formula (I), at least one compound of the general formula (II) and at least one compound of the general formula (III);
addition of at least one catalyst, in particular an acid, to the suspension of at least one compound of the formula (I), at least one compound of the formula (II) and at least one compound of the formula (III);
addition of at least one matting agent; and
Separation of the aqueous phase of the mixture of at least one compound of the formula (I), at least one compound of the formula (II), at least one compound of the formula (III) and the at least one matting agent.

Inorganic and/or organic acids suitable as catalysts are selected from a group containing phosphoric acid, acetic acid, p-toluene sulfonic acid, hydrochloric acid, formic acid or sulfuric acid. Also suitable are ammonium salts such as ammonium sulphate, which react as weak acids. p-toluene sulfonic acid is particularly preferred.

In a preferred embodiment, the method comprises the following steps:
Providing an alcoholic aqueous suspension, in particular an ethanolic aqueous suspension, containing at least one compound of the general formula (I), at least one compound of the general formula (II) and at least one, preferably two, compounds of the general formula (III);
adding at least one catalyst, in particular an acid, to the suspension of at least one compound of the formula (I), at least one compound of the formula (II) and at least one, preferably two, compounds of the formula (III) and heating the mixture;
Addition of an aqueous mixture comprising at least one matting agent, inorganic particles, at least one alcohol or at least one ether,
Separation of the aqueous phase of the mixture of at least one compound of the formula (I), at least one compound of the formula (II), at least one compound of the formula (III) and the at least one matting agent from the alcohol (e.g. by evaporation).

In the case that inorganic particles are added to the binder composition, the inorganic particles are preferably used in an amount between 0.1 to 15% by weight, preferably 0.5 to 10% by weight, more preferably between 1 to 5% by weight.

Phenoxyethanol, for example, can be used as the alcohol that is added to the aqueous mixture with the matting agent. As an alcohol, phenoxyethanol has a high flash point of 126° C., which is important for process reliability, also with regard to drying up too quickly. Other alcohols are also technically possible. Instead of the alcohol, an ether such as dipropylene glycol monomethyl ether can also be used in this process step.

The addition of an auxiliary agent for the separation and removal of the alcohol, especially the ethanol, from the aqueous phase has also proven to be effective. Acetate, such as n-butyl acetate, has shown to be very positive in terms of production time and subsequent stability in the aqueous medium. Instead of n-butyl acetate, 1-methoxy-2-propanol could also be used.

The aqueous suspension of the composition prepared in this way can be stirred into aqueous resins of all kinds, e.g. formaldehyde resins such as melamine resins, and used to create a matt and at the same time hydrophobic and oleophobic surface.

In a further embodiment, at least one silicone-containing additive may be added to the aqueous suspension as a flow agent, such as BYK-306. This additive reduces the surface tension and serves as a good mediator between the present composition with the silane compounds and an aqueous resin or water.

If the composition is to be incorporated into non-aqueous alcohol-based resins, such as acrylate, epoxy or urethane resins, the formulation is modified. Thus, in the first process step, the silanes are provided in a suspension with a reduced water content (e.g. 10 g water and 80 g 1-methoxy-2-propanol) (other alcohols are also possible).

The composition in a resin suspension can be used for coating carrier materials, in particular paper layers, such as decorative paper layers or overlay paper layers, or in particular wood-based panels, such as medium-density fibre (MDF), high-density fibre (HDF) boards or oriented strand board (OSB), plywood boards or a plastic composite (WPC) boards or stone plastic composite (SPC) boards.

The application of the resin suspension to a wood-based panel is typically done by means of rollers, and the application of the resin suspension to a paper layer is done by means of an anilox,

Accordingly, wood-based panels coated with the present composition and paper layers, preferably decorative paper layers or overlay paper layers, coated with the present composition are provided which have a reduced gloss level. The surfaces of the wood-based panels and paper layers coated with the present composition have gloss levels of less than 10, preferably less than 8, more preferably less than 5. Gloss levels of even less than 4, e.g. 3.1, 3.4 or 3.8, can be achieved.

As already mentioned, the present composition can be applied to a paper layer, whereby already impregnated paper layers (impregnates) are particularly preferred. As used herein, the term “impregnation” means a complete or partial impregnation of the paper layer with the resin. Such impregnations can be applied, for example, in an impregnation bath, by rolling, by screen rolling, by doctoring or also by spraying.

The paper layers used are, for example, overlay papers, decorative papers or kraft papers. Overlay papers are thin papers that have typically already been impregnated with a conventional melamine resin. There are also overlay papers available in which abrasion-resistant particles, such as corundum particles, are already mixed into the resin of the overlay to increase abrasion resistance. Decor papers are special papers for surface finishing of wood-based materials, which allow a high variety of decors. In addition to the typical imprints of various wood structures, more extensive imprints of geometric shapes or artistic products are available. In fact, there is no restriction in the choice of motif. To ensure optimal printability, the paper used must have good smoothness and dimensional stability and also be suitable for penetration of a necessary synthetic resin impregnation. Kraft papers have a high strength and consist of cellulose fibres to which starch, alum and glue are added to achieve surface effects and strength increases.

In one embodiment, the paper layers are treated as follows: First, the paper layer is impregnated on the reverse side (e.g. in an impregnation tank) with a resin with a solids content of between 50 and 70% by weight, preferably 60% by weight. After the paper has passed through a breathing zone, it is impregnated with a resin by dipping. In a squeegee system/pinch roller pair, excess resin is removed and optionally abrasion resistant particles are sprinkled on the impregnated paper layer. After a drying step, the resin suspension with a solids content between 50 and 70 wt %, preferably 55 wt % comprising the matting composition according to the solution is then applied. A further drying step is carried out to a residual moisture content of about 6%. The impregnate can then be pressed in the usual way with a wood-based panel, e.g. in a short-cycle press.

In another preferred embodiment, the composition is applied to a printed wood-based panel.

For this purpose, a wood-based panel or carrier panel is first provided with a resin base coat, on which at least one base coat layer is applied. The base coat layer preferably used comprises a composition of casein or soy protein as a binder and inorganic pigments, in particular inorganic colour pigments. White pigments such as titanium dioxide can be used as colour pigments in the base coat layer, or other colour pigments such as calcium carbonate, barium sulphate or barium carbonate. In addition to the colour pigments and the casein or soy protein, the base coat may also contain water as a solvent. It is also preferred if the applied pigmented base coat consists of at least one, preferably at least two, in particular preferably at least four successively applied layers or coatings, wherein the application quantity between the layers or coatings may be the same or different.

In another embodiment, a primer layer is applied to the base coat, preferably as a one-time application with subsequent drying. The primer layer is particularly useful in the case of a subsequent gravure printing process (with rollers), whereas it is not absolutely necessary when using a digital printing process.

The amount of liquid primer applied is between 10 and 30 g/m², preferably between 15 and 20 g/m². Polyurethane-based compounds are preferred as primers.

Gravure and digital printing processes are advantageously used as direct printing processes for printing the wood-based panel.

Covering layers with or without additives, which may vary in quantity and composition, are applied on top of the decorative layer.

Thus, the following orders can be carried out in one variant:
applying at least one first resin layer to the at least one decorative layer on the upper surface of the wood-based panel, the first resin layer having a solids content of between 60 and 80% by weight, preferably 65% by weight, and containing glass beads as spacers;
Drying of the assembly of first resin layer and glass beads in at least one drying device;
applying at least one second resin layer to the upper side and optionally to the lower side of the wood-based panel, wherein the second resin layer has a solids content of between 60 and 80 wt %, preferably 65 wt %;
uniform scattering of abrasion-resistant particles onto the second resin layer on the top of the wood-based panel;
subsequent drying of the second resin layer with the abrasion-resistant particles in at least one drying device;
applying at least a third and a fourth resin layer, the third having a solids content of between 50 and 70% by weight, preferably 60% by weight,
subsequent drying of the applied third resin layer in at least one further drying device;
applying at least fourth resin layer, wherein the fourth resin layer has a solids content between 50 and 70 wt %, preferably 60 wt %;
subsequent drying of the applied fourth resin layer in at least one further drying device;
applying at least one resin suspension having a solids content of between 50 and 70% by weight, preferably 55% by weight, comprising the composition according to the solution,
subsequent drying of the applied resin suspension in at least one further drying apparatus; and
Pressing of the layer structure in a short-cycle press.

As explained above, glass beads can be applied to act as spacers. The preferred glass beads have a diameter of 80-100 μm. The amount of glass beads is 10 to 50 g/m², preferably 10 to 30 g/m² , more preferably 15 to 25 g/m² . The batch preferably consists of about 40 kg resin liquid plus glass beads and auxiliary materials. The glass beads can also be in silanised form. Silanisation of the glass beads improves the embedding of the glass beads in the resin matrix.

As also mentioned above, abrasion-resistant particles, such as particles of corundum (aluminium oxides), boron carbides, silicon dioxides, silicon carbides, can be sprinkled onto the wood-based panel. Particles of corundum are particularly preferred. Preferably, these are high-grade corundum (white) with a high transparency, so that the optical effect of the underlying decor is adversely affected as little as possible.

The amount of scattered abrasion-resistant particles is 10 to 50 g/m², preferably 10 to 30 g/m², more preferably 15 to 25 g/m². The amount of scattered abrasion-resistant particles depends on the abrasion class to be achieved and the particle size. Thus, in the case of abrasion class AC3, the amount of abrasion-resistant particles is in the range between 10 to 15 g/m², in abrasion class AC4 between 15 to 20 g/m² and in abrasion class AC5 between 20 to 35 g/m² when using grit size F200. In the present case, the finished panels preferably have abrasion class AC4.

Abrasion-resistant particles with grain sizes in classes F180 to F240, preferably F200, are used. The grit size of class F180 covers a range of 53-90 μm, F220 from 45-75 μm, F230 34-82 μm, F240 28-70 μm (FEPA standard). In one variant, white corundum F230 is used as abrasion-resistant particles.

The drying of the resin layers takes place at dryer temperatures between 150 and 220° C., preferably between 180 and 210° C., especially in a convection dryer. The temperature is adapted to the respective resin layers and can vary in the individual convection dryers. However, other dryers can be used instead of convection dryers.

In the pressing step following the last drying step, the layer structure is pressed under the influence of pressure and temperature in a short-cycle press at temperatures between 150 and 250° C., preferably at 160° C., and a pressure between 30 and 60 kg/cm². The pressing time is between 10 and 20 sec, preferably between 12 and 14 sec.

Preferably, the coated wood-based panel is aligned in the short-cycle press with a structured press plate located in the short-cycle press by means of markings on the wood-based panel, so that a congruence is produced between the decor on the wood-based panel and the structure of the press plate to be imprinted. This enables the production of a decor-synchronous structure. During pressing, the melamine resin layers melt and form a laminate through a condensation reaction.

The solution is explained in more detail below with reference to examples of embodiments.

### EXAMPLE 1

a) Preparation of a First Matting Composition

50 g ethanol and 90 g water are placed in a stirring vessel. To this is now added a silane mixture of 27.6 g octyltriethoxysilane 23.4 g pentyltriethoxysilane/55.6 g glycidyloxypropyltriethoxysilane and 81.2 g tetraethoxysilane and stirred vigorously. Now a mixture of 10 g water and 5.2 g para toluene sulfonic acid is added and heated to 40° C. and stirred for 60 minutes.

After this time, another 50 g water as well as 10 g N-butyl acetate, 5 g 2-phenoxyethanol, as well as 65 g matting agent (deuteron 659) 35 g (syloid 244) are added and stirred at 40° C. for another 120 minutes. Subsequently, the ethyl alcohol is removed with the help of a rotary evaporator.

Now add 19 g of the levelling agent Byk 306 to 380 g of solution.

b) Preparation of a Second Matting Composition

50 g ethanol and 90 g water are placed in a stirring vessel. To this is now added a silane mixture of 27.6 g octyltriethoxysilane 51.1 g tridecafluorooctyltriethoxysilane/55.6 g glycidyloxypropyltriethoxysilane and 81.2 g tetraethoxysilane and stirred vigorously. Now a mixture of 10 g water and 5.2 g para toluene sulfonic acid is added and heated to 40° C. and stirred for 60 minutes.

After this time, another 50 g water as well as 10 g n-butyl acetate, 5 g 2-phenoxyethanol, as well as 65 g matting agent (deuteron 659) 35 g (syloid 244) are added and stirred at 40° C. for another 120 minutes. Subsequently, the ethyl alcohol is removed with the help of a rotary evaporator.

Now add 19 g of the levelling agent Byk 306 to 380 g of solution.

For incorporation into acrylic, epoxy or urethane resins on alcoholic basis or 100% systems, the above formulation is modified. The amount of water in the examples is replaced by 10 water and 80 g 1-methoxy-2-propanol). Other alcohols are also possible. The addition of the second amount of water (10 g) remains the same. Possibly, the rotary evaporation step to remove the ethanol can now be omitted. However, one could add a higher boiling alcohol like dipropylene glycol monomethyl ether and remove the low boiling alcohols, so that the flash point is brought further up.

### EXAMPLE 2

### Application of the Composition According to the Solution to a Decorative Paper

A decorative paper (grammage: 80 g/m²) is unwound from an unwinder in an impregnation channel. The decorative paper is first impregnated on the back with a melamine resin in an impregnation tank. The melamine resin has a solids content of approx. 60% by weight and contains the usual additives such as hardeners, wetting agents, separating agents, etc. After passing through the breathing section, the paper is impregnated with a melamine resin. The decor paper passes through squeeze rollers in which the resin application is adjusted to approx. 125 g liquid/m². The decor paper passes through a first floating dryer in which the decor paper is dried to a residual moisture of 15-20%.

In a screening unit, the top side of the decor paper is coated with a formulation of 100% by weight melamine resin (solids content: 55% by weight) and 95% by weight of the composition according to the solution (Inosil MM-32-x). The application quantity was 50 g formulation/m².

It is again dried in a flotation dryer. The residual moisture was then 6.0%.

The impregnate is cut to size and stacked. The impregnate was then pressed onto a chipboard panel in a short-cycle press (press parameters: p=40 kg/cm², T=200° C. top/200° C. bottom, t=14 sec). A press plate with a deckle structure was used.

After pressing, a gloss level determination (DIN EN ISO 2813:2015-02, measuring angle: 85°) was carried out, resulting in a value of 3.8 gloss points. An impregnate that had been impregnated with the composition according to the solution without the formulation yielded a value of 12.3 gloss points in the gloss level determination. The surface also had pronounced anti-fingerprint properties.

### EXAMPLE 3

### Application of the Composition According to the Solution to an Overlay Paper

An overlay paper (grammage: 30 g/m²) is unwound from an unwinder in an impregnation channel. The overlay paper is first impregnated on the back with a melamine resin in an impregnation tank. The melamine resin has a solids content of approx. 60% by weight and contains the usual additives such as hardeners, wetting agents. Release agent etc. After passing through the breathing section, the paper is impregnated with a melamine resin. The overlay paper passes through squeeze rollers in which the resin application is adjusted to approx. 180 g liquid/m². The overlay paper is then sprinkled with approx. 20 g corundum/m² (grain size: F230 according to FEPA standard) with the help of a spreader on the top side. Then the impregnate passes through a first floating dryer in which the overlay impregnate is dried to a residual moisture of 15-20%.

In a screening plant, the reverse side of the overlay paper is coated with a formulation of 100% by weight melamine resin (solids content: 55% by weight) and 95% by weight of the composition according to the solution (Inosil MM-32-x). The application rate was 50 g formulation/m². It was again dried in a flotation dryer. The residual moisture was then 6.0%.

The impregnated material is cut to size and stacked. The pallet with the impregnates is then turned (bottom side up). The impregnate was then pressed in a short-cycle press. The following structure was used: overlay impregnate—decorative impregnate—HDF (fibreboard with increased bulk density)—counter-impregnate.

With the exception of the overlay impregnate, the impregnates are standard products that can be procured from contract impregnators for this application.

The following pressing parameters were used: p=40 kg/cm², T=200° C. top/200° C. bottom, t=14 sec). A press plate with a deckle structure was used.

After pressing, a gloss level determination (DIN EN ISO 2813:2015-02, measuring angle: 85°) was carried out, resulting in a value of 3.1 gloss points. A structure that had been impregnated with an overlay impregnate without the composition according to the solution provided a value of 11.9 gloss points in the gloss level determination. The surface also had pronounced anti-fingerprint properties.

### EXAMPLE 4

### Application of the Composition According to the Solution to a Wood-Based Panel

An HDF (format: 2800×2070×7 mm) is first base coated with a melamine resin in a direct printing line (application quantity: approx. 20 g melamine resin fl./m², solids content: approx. 65 wt. %). The resin is dried in a circulating air dryer and then a colour base coat is applied, which consists of titanium dioxide and casein. This colour base coat is applied up to seven times. The application quantity is 5-10 g base coat fl./application. After each application, an intermediate drying is carried out with the help of a circulating air and/or IR dryer. Then a primer is applied (application quantity 10-20 g fl/m²). This is also dried. A decor is then printed onto this primer using gravure or digital printing.

Then a covering layer of melamine resin is applied (application quantity: 10-30 g melamine resin fl./m², solids content: 65 wt %). The melamine resin contains glass beads (diameter of glass beads: 80-100 μm, application quantity: 5 g glass beads/m²) as spacers. The boards again pass through a dryer. They are then cooled in a paternoster.

The boards are then coated on a production line on the top side with melamine resin (application quantity: 60 g melamine resin fl./m², solids: 65 wt %.). At the same time, a melamine resin is applied as a countercoat on the reverse side in the same quantity, also with the help of a roller. Then corundum is sprinkled on the top side of the board (application quantity: 20 g corundum/m², grain size: F230 according to FEPA standard). The structure is dried in a dryer with the help of IR radiators or circulating air. Subsequently, 30 g melamine resin fl./m² (solids content: 60 wt %) is applied twice more with the help of roller application units. Intermediate drying follows after each application.

In a final roller application unit, a formulation consisting of 100% by weight melamine resin (solids content: 55% by weight) and 95% by weight of the composition according to the solution (Inosil MM-32-x) was applied. The application quantity was 50 g formulation/m².

The boards are dried in a circulating air dryer. The boards are then placed in a lay-up station with a counter-impregnate and then transferred to a short-cycle press. There the structure is then pressed at T=160° C., p=30 kg/cm² and t=14 sec. A press plate with a deckle structure was used.

After pressing, a gloss level determination (DIN EN ISO 2813:2015-02, measuring angle: 85°) was carried out, resulting in a value of 3.4 gloss points. A structure that had been impregnated with an overlay impregnate without the formulation with the composition according to the solution provided a value of 12.3 gloss points in the gloss level determination. The surface also had pronounced anti-fingerprint properties.

### EXAMPLE 5

In addition to the gloss levels, other properties of the pressed wood-based panels were also examined for embodiments 1 and 2.

These are summarised in the following table.

| Ex. | Papers** | Acid test*** | Crosscut**** | Gloss level |
|---|---|---|---|---|
| treated OV | OV; D; G | 2 | 2 | 3.1 |
| Untreated OV | OV; D; G | 2 | 1 | 11.9 |
| Treated D | D; G | 2 | 2 | 3.8 |
| Untreated D | D; G | 1 | 2 | 12.3 |

**OV = Overlay; D = Decorative paper; G = Counterdraught
***1 = no change, test area cannot be distinguished from surrounding area;
2 = moderate change, test surface can be distinguished from surrounding surface when viewed from different directions, for example distance, gloss and colour changes, no perceptible change in the surface occurs
3 = strong change, surface structure clearly changed and/or discolouration, changes in gloss and colour and/or complete or partial delamination of the surface material.
****1 = at the intersections of the grid lines small splinters of the coating are chipped off, chipped off area not larger than 5% of the grid intersection area
2 = the coating is chipped along the cut edges and/or at the intersections of the grid lines, chipped area greater than 5% but not greater than 15% of the grid cut area
3 = the coating is chipped along the cut edges partially or completely wide strips and/or some squares are partially or completely chipped, chipped area greater than 15% but not greater than 35% of the grid cut area.

1-15. (canceled)

16. A method for coating surfaces of carrier materials with a resin suspension with matting and reducing anti-fingerprint effects based on a formaldehyde resin comprising a composition, said composition comprising:
at least one compound of the general formula (I)
SiX₄ (I),
where
X is H, OH or a hydrolysable moiety selected from the group comprising halogen, alkoxy, carboxy, amino, monoalkylamino or dialkylamino, aryloxy, acyloxy, alkylcarbonyl;
at least one compound of the general formula (II)
R¹ₐ SiX₍₄₋ₐ₎ (II),
where
X has the above meaning, and
R¹ is an organic moiety selected from the group comprising alkyl, aryl, cycloalkyl, and
wherein R¹ has at least one functional group Q₁ selected from a group containing a hydroxy, amino, monoalkylamino, carboxy, mercapto, alkoxy, aldehyde, acrylic, acryloxy, methacrylic, methacryloxy, cyano, isocyano and epoxy group, and
a=1, 2, 3, in particular 1 or 2, and
at least one compound of the general formula (III)
R²_{b} SiX_{(4-b)} (III),
wherein
X has the above meaning,
R² is a non-hydrolysable organic moiety R² selected from the group comprising alkyl, aryl, alkenyl, alkynyl, cycloalkyl, cycloalkenyl or perfluorinated alkyl; and
b=1, 2, 3, or 4, and
at least one matting agent comprising polymers and silica.

17. The method according to claim 16, wherein X is selected from a group containing H, OH, fluorine, chlorine, bromine, iodine, C₁₋₆-alkoxy, in particular methoxy, ethoxy, n-propoxy and butoxy, C₆₋₁₀-aryloxy, in particular phenoxy, C₂₋₇-acyloxy, in particular acetoxy or propionoxy, C₂₋₇-alkylcarbonyl, in particular acetyl, monoalkylamino or dialkylamino with C₁ to C₁₂, in particular C₁ to C₆.

18. The method according to claim 16, wherein X is H, OH or alkoxy, in particular methoxy, ethoxy, n-propoxy or i-propoxy

19. The method according to claim 16, wherein R¹ of the compound of the general formula (II) is selected from a group comprising C₁-C₃₀-alkyl, in particular C₅-C₂₅-alkyl, C₂-C₆-alkenyl, C₃-C₈-cycloalkyl and C₃-C₈-cycloalkenyl.

20. The method according to claim 16, wherein the at least one functional group Q¹ of the compound of the general formula (II) is selected from a group containing epoxy, hydroxy, ether, acrylic, acryloxy, methacrylic, methacryloxy, amino, alkoxy, cyano and/or isocyano group.

21. The method according to claim 16, wherein the non-hydrolyzable organic moiety R² of the compound of the general formula (III) is selected from a group comprising C₁-C₁₅-alkyl, in particular C₁-C₁₀-alkyl, C₂-C₆-alkenyl, C₂-C₆-alkynyl and C₆-C₁₀-aryl.

22. The method according to claim 16, wherein non-hydrolyzable organic R² of the compound of the general formula (III) is selected from the group comprising methyl, ethyl, n-propyl, isopropyl, n-butyl, s-butyl, t-butyl, pentyl, hexyl, heptyl, octyl, nonyl, cyclohexyl, vinyl, 1-propenyl, 2-propenyl, butenyl, acetylenyl, propargyl, phenyl and naphthyl.

23. The method according to claim 16, wherein at least one compound of the general formula (I), at least one compound of the general formula (II) and at least two compounds of the general formula (III) are contained.

24. The method according to claim 16, wherein the at least one matting agent comprises a composite of polyurethane, synthetic amorphous silica or monodisperse polysiloxane particles.

25. The method according to claim 16, wherein inorganic particles, in particular SiO₂, Al₂O₃, ZrO₂, TiO₂ particles, may be included.

26. The method according to claim 16, wherein the formaldehyde resin is a melamine resin.

27. The method according to claim 16 for coating carrier materials, in particular paper layers, such as decorative paper layers or overlay paper layers, or in particular wood-based panels, such as medium-density fibre (MDF), high-density fibre (HDF) boards or oriented strand board (OSB), plywood boards or a plastic composite (WPC) board or stone-plastic composite (SPC) board.

28. A resin suspension based on a formaldehyde resin comprising a composition for matting and reducing anti-fingerprint effects of surfaces on carrier materials, said composition being preparable from
at least one compound of the general formula (I)
SiX₄ (I),
where
X is H, OH or a hydrolysable moiety selected from the group comprising halogen, alkoxy, carboxy, amino, monoalkylamino or dialkylamino, aryloxy, acyloxy, alkylcarbonyl;
at least one compound of the general formula (II)
R¹ₐ SiX₍₄₋ₐ₎ (II),
where
X has the above meaning, and
R¹ is an organic moiety selected from the group comprising alkyl, aryl, cycloalkyl, and
wherein R¹ has at least one functional group Q₁ selected from a group containing a hydroxy, amino, monoalkylamino, carboxy, mercapto, alkoxy, aldehyde, acrylic, acryloxy, methacrylic, methacryloxy, cyano, isocyano and epoxy group, and
a=1, 2, 3, in particular 1 or 2, and
at least one compound of the general formula (III)
R²_{b} SiX_{(4-b)} (III),
wherein
X has the above meaning,
R² is a non-hydrolysable organic moiety R² selected from the group comprising alkyl, aryl, alkenyl, alkynyl, cycloalkyl, cycloalkenyl or perfluorinated alkyl; and
b=1, 2, 3, or 4, and
at least one matting agent comprising polymers and silica.

29. The resin suspension according to claim 28, wherein X is H, OH or alkoxy, in particular methoxy, ethoxy, n-propoxy or i-propoxy.

30. The resin suspension according to claim 28, wherein R¹ of the compound of the general formula (II) is selected from a group comprising C₁-C₃₀-alkyl, in particular C₅-C₂₅-alkyl, C₂-C₆-alkenyl, C₃-C₈-cycloalkyl and C₃-C₈-cycloalkenyl.

31. The resin suspension according to claim 28, wherein the at least one functional group Q¹ of the compound of the general formula (II) is selected from a group containing epoxy, hydroxy, ether, acrylic, acryloxy, methacrylic, methacryloxy, amino, alkoxy, cyano and/or isocyano group.

32. The resin suspension of claim 28, wherein the non-hydrolyzable organic moiety R² of the compound of the general formula (III) is selected from a group comprising C₁-C₁₅-alkyl, in particular C₁-C₁₀-alkyl, C₂-C₆-alkenyl, C₂-C₆-alkynyl and C₆-C₁₀-aryl.

33. The resin suspension of claim 28, wherein at least one compound of the general formula (I), at least one compound of the general formula (II) and at least two compounds of the general formula (III) are contained.

34. The resin suspension of claim 28, wherein the at least one matting agent comprises a composite of polyurethane, synthetic amorphous silica or monodisperse polysiloxane particles.

35. The resin suspension of claim 28, wherein the formaldehyde resin is a melamine resin.

36. A wood-based panel coated with at least one resin suspension according to claim 28.

37. A paper layer, preferably decorative paper layer or overlay paper layer, coated with at least one resin suspension according to claim 28.
